(19) United States
(12) Patent Application Publication
(10) Pub. No.: US 2013/0332472 A1
(43) Pub. Date: Dec. 12, 2013

(54) DEPLOYING INFORMATION REPORTING APPLICATIONS

(71) Applicants: Andreas Vogel, Rauenberg (DE); Sigo Henkel, Heidelberg (DE); Andrei Tsoganov, Nussioch (DE); Dominic P.O. Hehn, Speyer (DE)

(72) Inventors: Andreas Vogel, Rauenberg (DE); Sigo Henkel, Heidelberg (DE); Andrei Tsoganov, Nussioch (DE); Dominic P.O. Hehn, Speyer (DE)

(73) Assignee: SAP AG, Walldorf (DE)

(21) Appl. No.: 13/493,056

(22) Filed: Jun. 11, 2012

(51) Int. Cl. G06F 17/30

(52) U.S. Cl. 707/754; 707/705; 707/769; 707/E17.059

(57) ABSTRACT

Methods, systems, and apparatus, including computer programs encoded on a computer storage medium, for deploying information reporting applications. In one aspect, a method includes receiving, from a design system of one or more computers, a template for a display screen for information reporting. Configuration information is received from the design system, the configuration information including one or more data parameters for accessing data stored in a database. A request for information reporting is received from a user system of one or more computers executing a display application. The data is accessed in the database according to the database parameters, and the data is provided to the user system for display in the display screen by the display application according to the template.

### TECHNICAL BACKGROUND

This disclosure relates to information management, and more particularly, to systems, software, and computer-implemented methods for deploying information reporting applications.

### BACKGROUND

Businesses and other organizations often collect large amounts of data related to operations, e.g., product development, manufacturing, distribution, sales, marketing, and financial operations. Executives and other people in the organization can monitor the organization using a business information dashboard. A dashboard is a display of information, e.g., a web page or other computer-based presentation. A dashboard can provide important business metrics, key performance indicators (KPIs), and the like in a convenient format. The information can be presented in graphs, tables, charts, individual numerical values, and the like.

### SUMMARY

In general, one aspect of the subject matter described in this specification can be embodied in methods that include the actions of receiving, from a design system of one or more computers, a template for a display screen for information reporting; receiving, from the design system, configuration information for information reporting, the configuration information including one or more data parameters for accessing data stored in a database; receiving, from a user system of one or more computers executing a display application, a request for information reporting; accessing the data in the database according to the database parameters; and providing the data to the user system for display in the display screen by the display application according to the template. Other embodiments of this aspect include corresponding systems, apparatus, and computer programs, configured to perform the actions of the methods, encoded on computer storage devices. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

These and other embodiments can each optionally include one or more of the following features. The actions further include receiving raw data from a plurality of enterprise software applications and storing the raw data in the database; determining one or more key performance indicators (KPIs) for the enterprise software applications using the configuration information; and providing the KPIs to the user system for display in the display screen by the display application. Determining the KPIs includes one or more of: filtering the raw data, performing data composition on the raw data, performing data aggregation on the raw data, determining correlations in the raw data, and determining Service Level Agreement (SLA) configuration information using the raw data. The one or more data parameters specify one or more queries to fetch the data from the database. The one or more data parameters specify one or more filter values or one or more formulas used for information reporting. The one or more data parameters specify text to displayed with data in the display screen. Receiving the request includes receiving, for the user system, identification information specifying a type of the user system; and providing the template to the user system includes modifying the template for compatibility with the type of the user system and providing the modified template to the user system. The template defines one or more graphs or charts to be displayed in the display screen.

Particular embodiments of the subject matter described in this specification can be implemented so as to realize one or more of the following advantages. Dashboard applications can be implemented without a specific implementation on a backend system, code modifications to front end applications are not necessary if the application content needs to be changed. Key performance indicators (KPIs) do not need to be calculated at the front end application, so large data transfers can be avoided. An arbitrary number of data suppliers and types of data can be provided for use in dashboard applications and updated without code updates. Due to KPIs being calculated in the back end, system security can be improved because detailed data—which is potentially sensitive—is not sent over the network and therefore not exposed to network traffic sniffing.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a schematic diagram of an example dashboard system configured to facilitate dashboard displays and other types of information reporting displays.

FIG. 2. illustrates an example dashboard display as presented in a web browser of a user device.

FIG. 3 is a flow diagram of an example method for deploying a dashboard application.

FIG. 4 is a flow diagram of an example method for executing dashboard applications.

### DETAILED DESCRIPTION

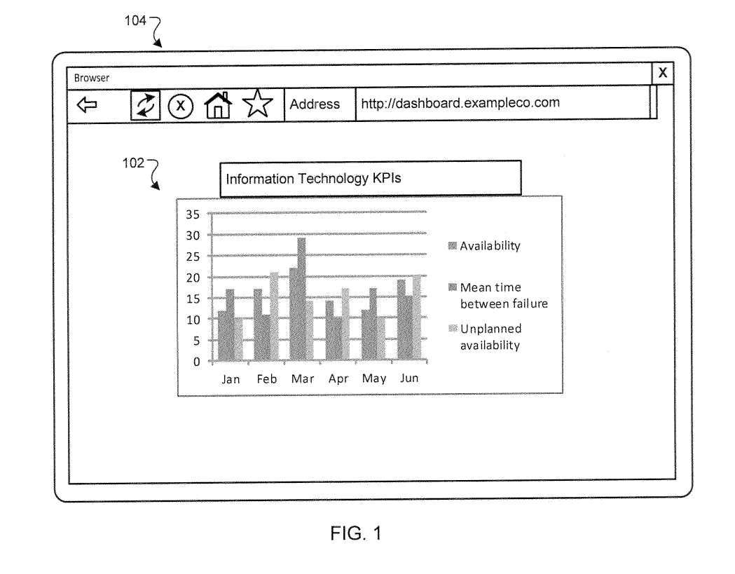

FIG. 1 is a schematic diagram of a dashboard system 102 configured to facilitate dashboard displays and other types of information reporting displays. The dashboard system can be implemented as a system of one or more computers. The one or more computers can be distributed geographically.

The dashboard system communicates with a design system 104 and a user system 106 over a data communications network 108 to create dashboard displays and other types of information reporting displays. The dashboard system includes a database 110 storing data used for the dashboard displays. Raw data from various sources can be stored in the database. The database can include data reported from various types of enterprise software applications, e.g., customer relationship management (CRM) applications, enterprise resource planning (ERP) applications, human resource management (HRM) applications, content management (CM) applications, and other enterprise software applications. The database can include other kinds of data.

A designer on the design system deploys a dashboard application by sending a template and configuration information for the dashboard application to the dashboard system. After deployment, a user on the user system uses the dashboard application by executing a display application to display a display screen of the dashboard application and access information specified by the dashboard application.

Different users on different users systems can use the dashboard application. In some implementations, the dashboard application can be configured to display different types of information depending on a user role. For example, the designer can deploy the dashboard application by sending different templates and configuration information to the dashboard system. The user system, then, sends the user role to the dashboard system, which responds with the appropriate information.

### Deploying the Dashboard Application

To deploy a dashboard application, a designer uses the design system to create a template and configuration information for a dashboard application, and then the designer uses the design system to provide the template and configuration information to the dashboard system.

The designer can use a template application 112 that executes on the design system to create the template for the dashboard application. The template application can be, for example, a spreadsheet application or other application configured to accept data as input and produce charts and graphs and other graphical displays of information. The designer uses the template application to organize the data input and the graphical displays of information. When the designer has specified the graphical displays of information, the template application outputs a template. The template can be, for example, an Adobe® Flash® file, or a file for Web Dynpro by SAP®, or a Hypertext Markup Language (HTML) or HTML5 file, or a Javascript file.

The designer uses the design system to create configuration information for the dashboard application. The configuration information includes parameters that specify how data is accessed from the database and displayed in the display of the dashboard application. The configuration information can include parameters, for example, that specify where certain data is stored in the database, how to access certain data in the database, query names for queries used to fetch data from the database, filter values, formulas, text to displayed in display of the dashboard application, and so on.

The design system provides the template and the configuration information to a dashboard persistency layer 114 of the dashboard system. The dashboard persistency layer stores the template in a repository 116 of templates and stores the configuration information in a repository 118 of configuration information. The dashboard persistency layer can store templates and configuration for various dashboard applications.

### Using the Dashboard Application

To use a deployed dashboard application, a user executes a display application 120 on the user device. The display application can be a web browser or other application. The display application communicates with a dashboard provisioning layer 122 of the dashboard system.

The dashboard provisioning layer manages dashboard applications at run time. When the dashboard provisioning layer receives a request from a display application, the dashboard provisioning layer creates an instance in memory of the dashboard system for the display application, retrieves data from external systems if necessary, fetches data from the database, performs any requested computations, and provides information for displaying a dashboard in the display application.

The dashboard provisioning layer includes a dashboard services module 124 and a content provisioning module 126. The dashboard services module manages executing dashboard applications. The content provisioning module accesses data in the database, and the content provisioning module can retrieve data from external systems to store in the database. The content provisioning module can perform calculations using the data in the database, e.g., to determine KPIs. For example, the content provisioning module can perform filtering on the data, data composition, data correlation, data aggregation, Service Level Agreement (SLA) configuration calculations, and so on.

The dashboard provisioning layer, using the dashboard services module and the content provisioning module acting together, accesses the template and configuration information for a dashboard application and provides a generic representation of the dashboard to a user interface (UI) technology layer 128. The UI technology layer converts the generic representation of the dashboard to a specific representation to provide to the user device.

For example, the user device can provide information specifying that it is a certain type of user device, e.g., desktop, laptop, mobile phone, tablet, executing a certain operating system, and so on. The UI technology layer can convert the generic representation of the dashboard to a specification representation specific to the type of user device. The display application on the user device receives the specific representation of the dashboard and presents the dashboard to the user. Because the display application does not need to perform calculations performed by the dashboard provisioning layer, large data transfers between the dashboard system and the user system can be avoided.

In some implementations, the dashboard provisioning layer can filter the aggregated data based on a user role. For example, if a logged on user is a manager responsible for a particular department, the dashboard provisioning layer can aggregate the revenues generated by his department only, keeping potentially sensitive information about other departments private from the manager.

### Updating the Dashboard Application

To update the dashboard application, a designer on the design system need only update the template and/or configuration information for the dashboard application with the dashboard persistency layer. Hence, the display application on the user device need be updated, preventing a potentially costly code update. Moreover, if a data supplier changes the format of its information, or the database changes in some way, the designer need only update the configuration information for the dashboard application.

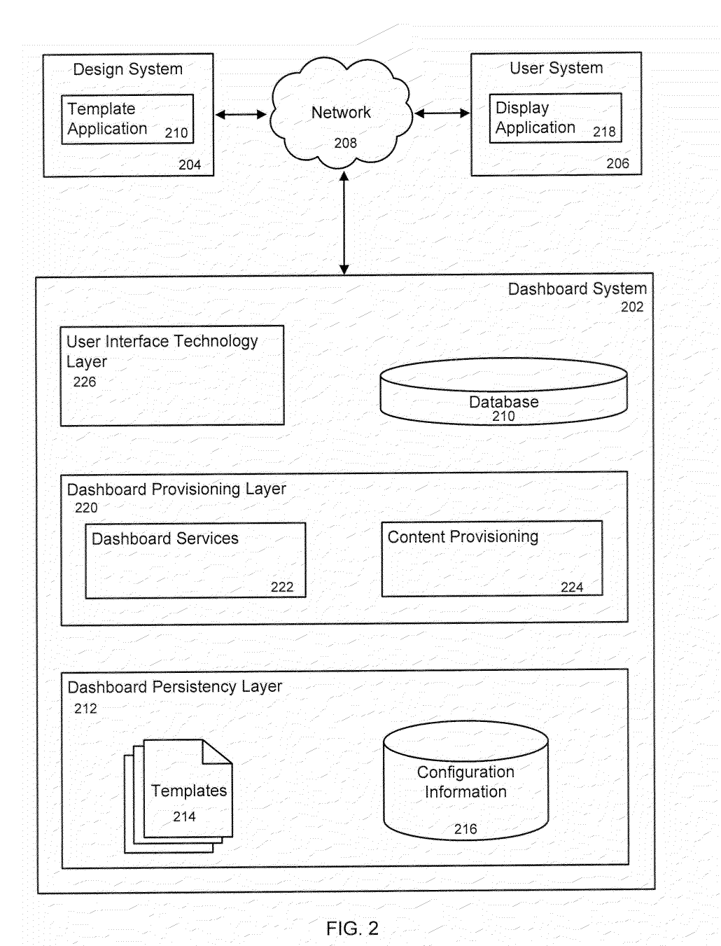

FIG. 2 illustrates an example dashboard display 202 as presented in a web browser 204 of a user device. The dashboard display is an example of an information reporting display, and the web browser is an example of a display application configured to display information reporting displays on a user device. The dashboard display includes a graph of key performance indicators (KPIs) and text above the graph. KPIs are an example of the kind of information that is typically presented in a dashboard display. Dashboard displays can display data in various formats, e.g., graphs, tables, charts, individual numerical values, and so on.

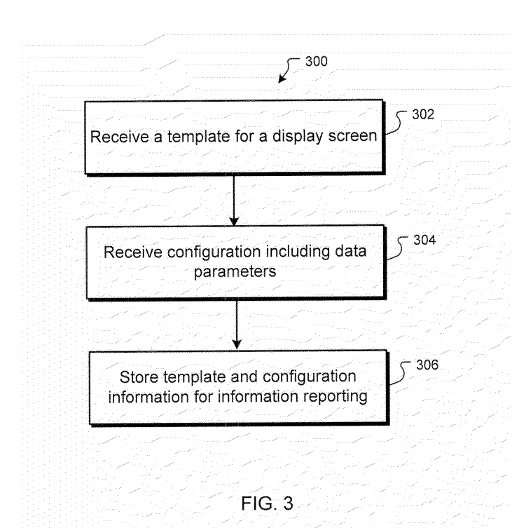

FIG. 3 is a flow diagram of an example method 300 for deploying a dashboard application. The method can be performed by a system of one or more computers. For example, the dashboard system 102 of FIG. 1 can perform the method. For purposes of illustration, the method will be described with respect to a system that performs the method.

The system receives a template for a display screen from a design system (302). The design system can be the design system 104 of FIG. 1. FIG. 2 illustrates an example display screen.

The system receives configuration information from the design system (304). The configuration information includes one or more data parameters for accessing data stored in a database. For example, the configuration information can specify one or more queries to fetch the data from the database, one or more filter values or formulas to be used on the data, text to displayed the with data, and so on. The configuration data can also include information for determining KPIs using the accessed data.

The system stores the template and the configuration information (306). The system can store the template in a repository of templates, e.g., the repository 116 of FIG. 1. The system can store the configuration information in a repository of configuration information, e.g., the repository 118 of FIG. 1. The system stores the template and the configuration information so that both can be used together during execution of a dashboard application.

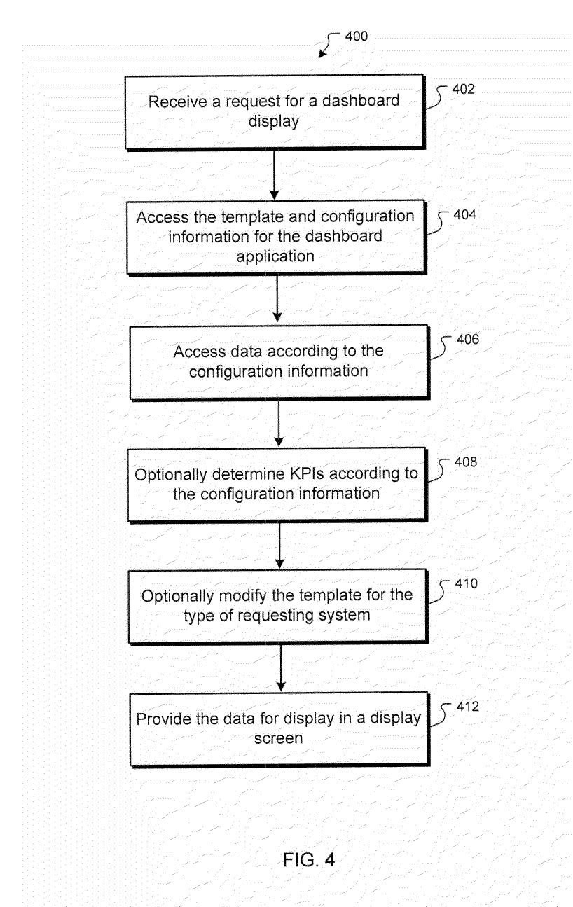

FIG. 4 is a flow diagram of an example method 400 for executing dashboard applications. The method can be performed by a system of one or more computers. For example, the dashboard system 102 of FIG. 1 can perform the method. For purposes of illustration, the method will be described with respect to a system that performs the method.

The system receives a request from a display application on a user system for a dashboard display (402). The system accesses a stored template and configuration information for a dashboard application for the dashboard display (404). The system accesses data according to the configuration information (406).

The system optionally determines KPIs using the data and the configuration information (408). The system optionally receives, with the request from the user system, identification information specifying a type of the user system and modifies the stored template for compatibility with the type of user system (410).

The system provides the data for display in a display screen of the display application according to the template (412). The system can provide the modified template to the display application.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
receiving, from a design system of one or more computers, a template for a display screen for information reporting;
receiving, from the design system, configuration information for information reporting, the configuration information including one or more data parameters for accessing data stored in a database;
receiving, from a user system of one or more computers executing a display application, a request for information reporting;
accessing the data in the database according to the database parameters; and
providing the data to the user system for display in the display screen by the display application according to the template.

2. The method of claim 1, further comprising:
receiving raw data from a plurality of enterprise software applications and storing the raw data in the database;
determining one or more key performance indicators (KPIs) for the enterprise software applications using the configuration information; and
providing the KPIs to the user system for display in the display screen by the display application.

3. The method of claim 2, wherein determining the KPIs includes one or more of:
filtering the raw data, performing data composition on the raw data, performing data aggregation on the raw data, determining correlations in the raw data, and determining Service Level Agreement (SLA) configuration information using the raw data.

4. The method of claim 1, wherein the one or more data parameters specify one or more queries to fetch the data from the database.

5. The method of claim 1, wherein the one or more data parameters specify one or more filter values or one or more formulas used for information reporting.

6. The method of claim 1, wherein the one or more data parameters specify text to displayed with data in the display screen.

7. The method of claim 1, wherein:
receiving the request includes receiving, for the user system, identification information specifying a type of the user system; and
providing the template to the user system includes modifying the template for compatibility with the type of the user system and providing the modified template to the user system.

8. The method of claim 1, wherein the template defines one or more graphs or charts to be displayed in the display screen.

9. A computer storage medium encoded with a computer program, the program comprising instructions that when executed by one or more computers cause the one or more computers to perform operations comprising:
receiving, from a design system of one or more computers, a template for a display screen for information reporting;
receiving, from the design system, configuration information for information reporting, the configuration information including one or more data parameters for accessing data stored in a database;
receiving, from a user system of one or more computers executing a display application, a request for information reporting;
accessing the data in the database according to the database parameters; and
providing the data to the user system for display in the display screen by the display application according to the template.

10. The computer storage medium of claim 9, the operations further comprising:
receiving raw data from a plurality of enterprise software applications and storing the raw data in the database;
determining one or more key performance indicators (KPIs) for the enterprise software applications using the configuration information; and
providing the KPIs to the user system for display in the display screen by the display application.

11. The computer storage medium of claim 10, wherein determining the KPIs includes one or more of: filtering the raw data, performing data composition on the raw data, performing data aggregation on the raw data, determining correlations in the raw data, and determining Service Level Agreement (SLA) configuration information using the raw data.

12. The computer storage medium of claim 9, wherein the one or more data parameters specify one or more queries to fetch the data from the database.

13. The computer storage medium of claim 9, wherein the one or more data parameters specify one or more filter values or one or more formulas used for information reporting.

14. The computer storage medium of claim 9, wherein the one or more data parameters specify text to displayed with data in the display screen.

15. The computer storage medium of claim 9, wherein:
receiving the request includes receiving, for the user system, identification information specifying a type of the user system; and
providing the template to the user system includes modifying the template for compatibility with the type of the user system and providing the modified template to the user system.

16. The computer storage medium of claim 9, wherein the template defines one or more graphs or charts to be displayed in the display screen.

17. A system of one or more computers configured to perform operations comprising:
receiving, from a design system of one or more computers, a template for a display screen for information reporting;
receiving, from the design system, configuration information for information reporting, the configuration information including one or more data parameters for accessing data stored in a database;
receiving, from a user system of one or more computers executing a display application, a request for information reporting;
accessing the data in the database according to the database parameters; and
providing the data to the user system for display in the display screen by the display application according to the template.

18. The system of claim 17, further comprising:
receiving raw data from a plurality of enterprise software applications and storing the raw data in the database;
determining one or more key performance indicators (KPIs) for the enterprise software applications using the configuration information; and
providing the KPIs to the user system for display in the display screen by the display application.

19. The system of claim 18, wherein determining the KPIs includes one or more of: filtering the raw data, performing data composition on the raw data, performing data aggregation on the raw data, determining correlations in the raw data, and determining Service Level Agreement (SLA) configuration information using the raw data.

20. The system of claim 17, wherein the one or more data parameters specify one or more queries to fetch the data from the database.
